(19) United States
(12) Patent Application Publication
(10) Pub. No.: US 2014/0373450 A1
(43) Pub. Date: Dec. 25, 2014

(54) LATCH MECHANISMS WITH ROTATING LATCH BOLTS AND TILT WINDOW ASSEMBLIES USING SAME

(71) Applicant: Andersen Corporation, Bayport, MN (US)

(72) Inventors: Dominick Benevenga, North Haledon, NJ (US); Juan Cornejo, East Brunswick, NJ (US)

(21) Appl. No.: 14/315,046

(22) Filed: Jun. 25, 2014

Related U.S. Application Data
(60) Provisional application No. 61/838,969, filed on Jun. 25, 2013.

(51) Int. Cl. E05C 5/04

(52) U.S. Cl. CPC E05C 5/04
USPC 49/183; 292/137

(57) ABSTRACT

An exemplary tilt latch mechanism including a latch bolt configured to rotate about a bolt axis to locate a portion of the latch bolt adjacent a portion of a latch, or jamb, channel for support is described herein. The latch bolt may include a foot portion configured to, e.g., distribute forces within the latch channel.

### CROSS REFERENCE TO RELATED APPLICATION

This application claims the benefit of U.S. Provisional Patent Application Ser. No. 61/838,969 entitled “LATCH MECHANISMS WITH ROTATING LATCH BOLTS AND TILT WINDOW ASSEMBLIES USING SAME” and filed on Jun. 25, 2013, which is incorporated herein by reference in its entirety.

### BACKGROUND

Latch mechanisms with rotating latch bolts and tilt window assemblies using the latch mechanisms are described herein.

Tilt sash windows (e.g., vinyl tilt sash windows, wood tilt sash windows, metal tilt sash windows, etc.) may not stand up well in high winds such as provided by hurricanes. The tilt latches may fail (e.g., break, detach, etc.) and/or the structure around the tilt latches such as the frame or sash of the window may break. Some conventional ways of reinforcing the window frame of the tilt sash windows may include adding fixed reinforcement members to the channel of the jamb in which the sash runs (the reinforcement members are fixedly coupled to the channel so as to restrict any movement of the reinforcement members relative the channel). Such fixed reinforcement members may limit the travel of the window when attempting to lift it to its maximum opening, which may interfere with the ability of the window to meet one or more standards regarding certain opening sizes for emergency egress.

### SUMMARY

The present disclosure describes exemplary latch mechanisms with rotating latch bolts and tilt window assemblies to provide support to the sash and latch mechanism to, e.g., withstand high winds and/or forces (such as from hurricanes). Generally, a foot portion of a latch bolt of the exemplary latch mechanisms may engage a larger surface area than traditional latch bolts to, e.g., disperse forces applied to the sash over a larger area, to provide additional support, etc.

One exemplary tilt window assembly may include a window frame, a first, or upper, sash, a second, or lower, sash, a first latch channel, a second latch channel, a first latch mechanism, and a second latch mechanism. The window frame may include a first jamb and a second jamb and may define a frame opening. The first sash may be mounted in the frame opening between the first and second jambs and the second sash may be mounted in the frame opening between the first and second jambs. Further, the second sash may be configured to move along a length of the first and second jambs between an open position and a closed position.

The first latch channel may be located in the first jamb and may extend along a first longitudinal axis, and the second latch channel may be located in the second jamb and may extend along a second longitudinal axis. Each of the first and second latch channel may include, in a cross-sectional view taken transverse to the longitudinal axis, a base located distal from the first and second sashes and at least one L-shaped portion (e.g., two L-shaped portions) extending away from the base towards the first and second sashes. The at least one L-shaped portion may include a leg and a flange extending from the leg, and the flange may be aligned with the base and the leg connects the flange to the base.

Each of the first and second latch mechanism may be attached to the second sash and may include a latch bolt configured to move between a retracted position and an extended position along a bolt axis. The latch bolt may include a foot (e.g., a L-shaped foot, a T-shaped foot, etc.) located in the latch channel when the latch bolt is in the extended position, and may be configured to rotate about the bolt axis from an insertion position to an engagement position. The foot may be configured to engage one or more portions of the channel to provide additional support with the channel, to transmit or transfer forces between the sash and the channel, etc. In at least one embodiment, the foot may define one or more bearing ends configured to be located adjacent one or more portions of the channel. For example, a bearing end of the foot (e.g., a L-shaped foot) may be located closer to the leg of the L-shaped portion of the latch channel when the latch bolt is in the engagement position than when the latch bolt is in the insertion position. Further, for example, a first bearing end of the foot (e.g., a T-shaped foot) may be located closer to the leg of the L-shaped portion of the latch channel and a second bearing end of the foot may be located closer to the leg of the opposite L-shaped portion of the latch channel when the latch bolt is in the engagement position than when the latch bolt is in the insertion position.

In one or more embodiments, the tilt window assembly may include a single latch mechanism including a first latch bolt configured to interoperate with the first latch channel and a second latch bolt configured to interoperate with the second latch channel. The exemplary single latch mechanism may be integrated with the key mechanism (e.g., a window lock) configured to lock the first sash and the second sash from moving with respect to each other (e.g., to lock the window).

In one or more embodiments, the foot of the latch bolt of the first latch mechanism may not be inserted into the first latch channel when the latch bolt of the first latch mechanism is in the engagement position and/or the foot of the latch bolt of the second latch mechanism may not be inserted into the second latch channel when the latch bolt of the second latch mechanism is in the engagement position.

In one or more embodiments, the flange of the first latch channel may be located between the bearing end of the foot of the latch bolt of the first latch mechanism and the second sash when that latch bolt is in the engagement position and the flange of the first latch channel may not be located between the bearing end of the foot of the latch bolt of the first latch mechanism and the second sash when that latch bolt is in the insertion position and/or the flange of the second latch channel may be located between the bearing end of the foot of the latch bolt of the second latch mechanism and the second sash when that latch bolt is in the engagement position and the flange of the second latch channel may not be located between the bearing end of the foot of the latch bolt of the second latch mechanism and the second sash when that latch bolt is in the insertion position.

In one or more embodiments, the tilt window assembly may further include a sash lock mechanism configured to restrict movement between the first sash and the second sash when engaged. Further, at least one of the first latch mechanism and the second latch mechanism may be operatively coupled to the sash lock mechanism to move the latch bolt into the retracted position, the extended position, the insertion position, and the engagement position. In at least one embodiment, at least one of the first latch mechanism and the second latch mechanism are integral into the second sash.

One exemplary latch apparatus may be configured for use in a tilt window assembly. The tilt window assembly may include a first sash and a second sash and define a latch channel in a jamb. The latch channel may extends along a longitudinal (e.g., vertical) axis and include, in a cross-sectional view taken transverse to the longitudinal axis, a base located distal from the first and second sashes and an L-shaped portion extending away from the base towards the first and second sashes, the L-shaped portion including a leg and a flange extending from the leg. The flange may be aligned with the base and the leg connects the flange to the base. The exemplary latch apparatus may include a latch bolt configured to move between a retracted position and an extended position along a bolt axis. The latch bolt may include a foot located in the latch channel when the latch bolt is in the extended position. Further, the latch bolt may be configured to rotate about the bolt axis from an insertion position to an engagement position. A bearing end of the foot may be located closer to the leg of the L-shaped portion of the first latch channel when the latch bolt is in the engagement position than when the latch bolt is in the insertion position. In at least one embodiment, the latch apparatus further includes a sash lock mechanism configured to restrict movement between the first sash and the second sash when engaged and operatively coupled to the latch bolt to move the latch bolt into the refracted position, the extended position, the insertion position, and the engagement position. In at least one embodiment, the latch apparatus may further include a latch body coupled the second sash. The latch body may be movably coupled to the latch body. In at least one embodiment, the latch body is integral with the second sash.

In one or more embodiments, the foot of the latch bolt may not be inserted into the latch channel when the latch bolt of the latch mechanism is in the engagement position.

In one or more embodiments, the flange of the latch channel may be located between the bearing end of the foot of the latch bolt of the latch mechanism and the second sash when that latch bolt is in the engagement position, and the flange of the latch channel may be not located between the bearing end of the foot of the latch bolt of the latch mechanism and the second sash when that latch bolt is in the insertion position.

In one or more embodiments, the bearing end of the foot portion may include a variety of shapes to, e.g., facilitate rotation of the foot portion about the bolt axis within the channel. In at least one embodiment, the bearing end of the foot is rounded. In at least one embodiment, the foot portion is T-shaped and includes two bearing surfaces.

One exemplary latch apparatus may be configured for use in a tilt window assembly including a window sash. The exemplary latch apparatus may include a latch body couplable to a window sash (e.g., integral with the window sash) and a latch bolt movably coupled to the latch body and configured selectively allow the window sash to tilt. The latch bolt may be configurable in a retracted position and an extended position. The latch bolt may restrict the sash from tilting when in the extended position and allows the sash to tilt when in the retracted position. Further, the latch bolt may be configured to move between a retracted position and an extended position along a bolt axis. The latch bolt may be further configured to selectively provide additional support to the tilt window assembly when in the extended position. Still further, the latch bolt may be configured to rotate about the bolt axis from an insertion position to an engagement position where the latch bolt provides additional support to the tilt window assembly when in an engagement position. In at least one embodiment, the latch apparatus may further include a sash lock mechanism configured to restrict movement between the window sash and another window sash when engaged and operatively coupled to the latch bolt to move the latch bolt into the retracted position, the extended position, the insertion position, and the engagement position.

In one or more embodiments, the latch bolt may include a foot portion locatable in a latch channel when the latch bolt is in the extended position. A bearing end of the foot portion may be located proximate a surface of the tilt window assembly parallel to the bolt axis when the latch bolt is in the engagement position.

In one or more embodiments, the latch bolt may include a foot portion locatable in a latch channel when the latch bolt is in the extended position, and the foot portion of the latch bolt may not be insertable into the latch channel when the latch bolt of the latch mechanism is in the engagement position.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 is a perspective view of an exemplary tilt window assembly.

FIGS. 2A-2B are side views of an exemplary latch mechanism of the tilt window assembly of FIG. 1 with a latch bolt in the extended/engagement position and retracted/insertion position, respectively.

FIGS. 3A-3B are end views of an exemplary latch mechanism of the tilt window assembly of FIG. 1 with a latch bolt in the extended/engagement position and retracted/insertion position, respectively.

FIGS. 4A-4C are top cross-sectional views of a portion of the tilt window assembly of FIG. 1 with an exemplary latch bolt in the engagement position, an insertion position, and retracted position, respectively.

FIGS. 5A-5C are side views of the exemplary latch mechanism of FIGS. 4A-4C with the latch bolt in the engagement position, an insertion position, and retracted position, respectively.

FIGS. 6A-6C are top cross-sectional views of a portion of the tilt window assembly of FIG. 1 with an exemplary latch bolt in the engagement position, an insertion position, and retracted position, respectively.

FIGS. 7A-7C are side views of the exemplary latch mechanism of FIGS. 6A-6C with the latch bolt in the engagement position, an insertion position, and retracted position, respectively.

FIGS. 8-9 are perspective views of exemplary tilt window assemblies.

### DETAILED DESCRIPTION OF EXEMPLARY EMBODIMENTS

In the following detailed description of illustrative embodiments, reference is made to the accompanying figures of the drawings which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

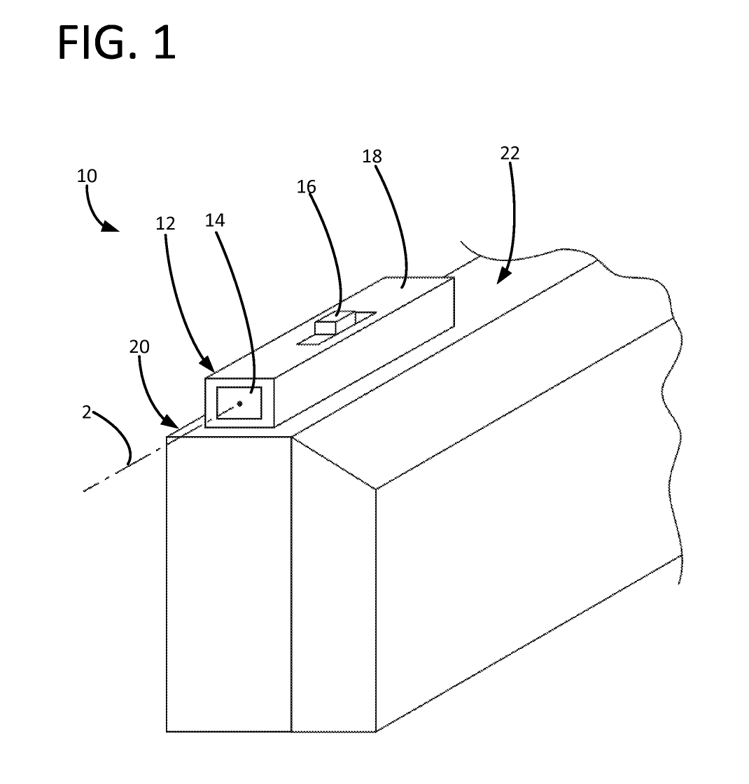

Exemplary apparatus shall be described with reference to FIGS. 1-9. It will be apparent to one skilled in the art that elements from one embodiment may be used in combination with elements of the other embodiments, and that the possible embodiments of such apparatus using combinations of features set forth herein is not limited to the specific embodiments shown in the figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

An exemplary latch mechanism, or apparatus, 10 for use in a tilt window assembly is depicted in FIG. 1. The latch mechanism 10 is depicted as being attached to a top, or upper, portion 22 of a sash 20 (e.g., lower sash) of a window. For example, the latch mechanism 10 may include latch body 18 that is coupled (e.g., fixedly coupled) to the top portion 22 of the sash 20 or integral with the sash 20. The sash 20 may be located in an opening defined by a window frame that includes a first jamb and second jamb. In a typical tilt window assembly, a first, or upper, sash may be mounted in the opening between first and second jambs, and a second, or lower, sash 20 may be mounted in the opening between the first and second jambs and generally below the first sash. The second sash 20 may be configured to move along a length of the first and second jambs between an open position and a closed position. For example, the second sash 20 may move upwardly to be adjacent the first sash. Additionally, the second sash 20 may be configured to be tilted open when located in the closed position to leave the area where the second sash 20 was formerly located open. For example, the second sash 20 may tilt about a lower portion of the second sash 20 such that an upper portion 22 of the second sash may move, or swivel, away from the first sash.

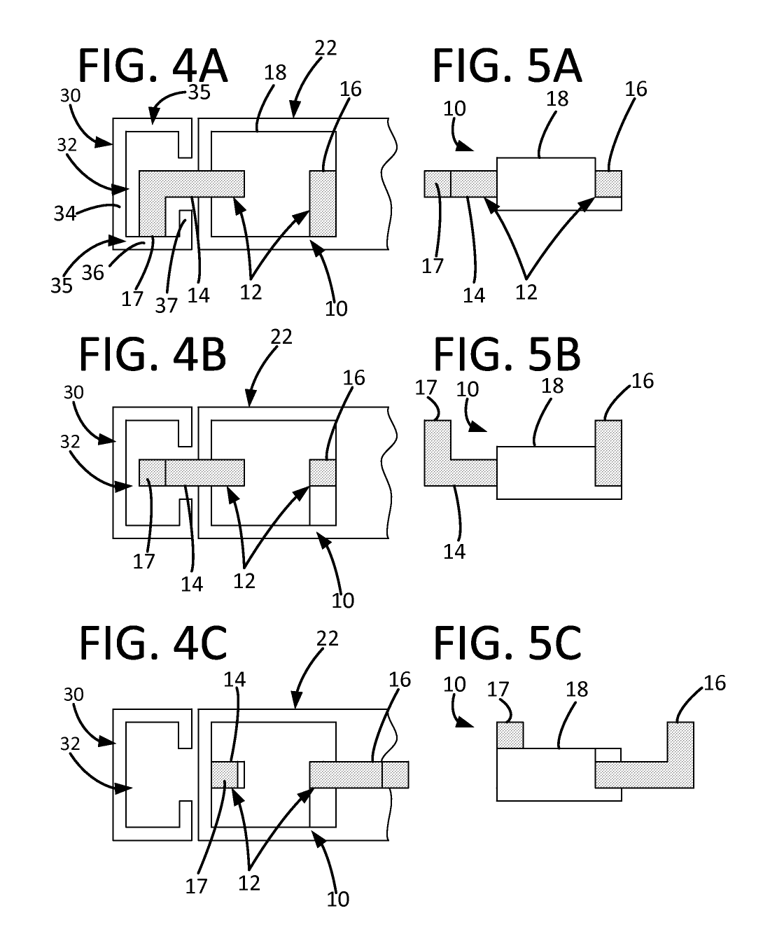

To keep, or maintain, the second sash 20 from tilting, an exemplary latch mechanism, or apparatus, 10 may be used to mate with, or be coupled to, a latch channel. Generally, a latch, or jamb, channel may be located in each of the first and second jambs of the window frame and may extend along a vertical axis (e.g. an axis perpendicular to a ground or floor surface). The latch channel 32 of each jamb 30 may include, in a cross-sectional view taken transverse to the longitudinal axis as shown in FIGS. 4A-4C, a base 34 located distal from the first and second sashes and a pair of L-shaped portions 35 extending away from the base 34 towards the first and second sashes. Each L-shaped portion 35 may include a leg 36 and a flange 37 extending from the leg 36. The flange 37 may be aligned with (e.g., parallel to) the base 34 and the leg 36 may connect, or couple, the flange 37 to the base 34. In other words, the latch channel may define a squared “C”-shape when viewed cross-sectionally as depicted in FIGS. 4A-4C.

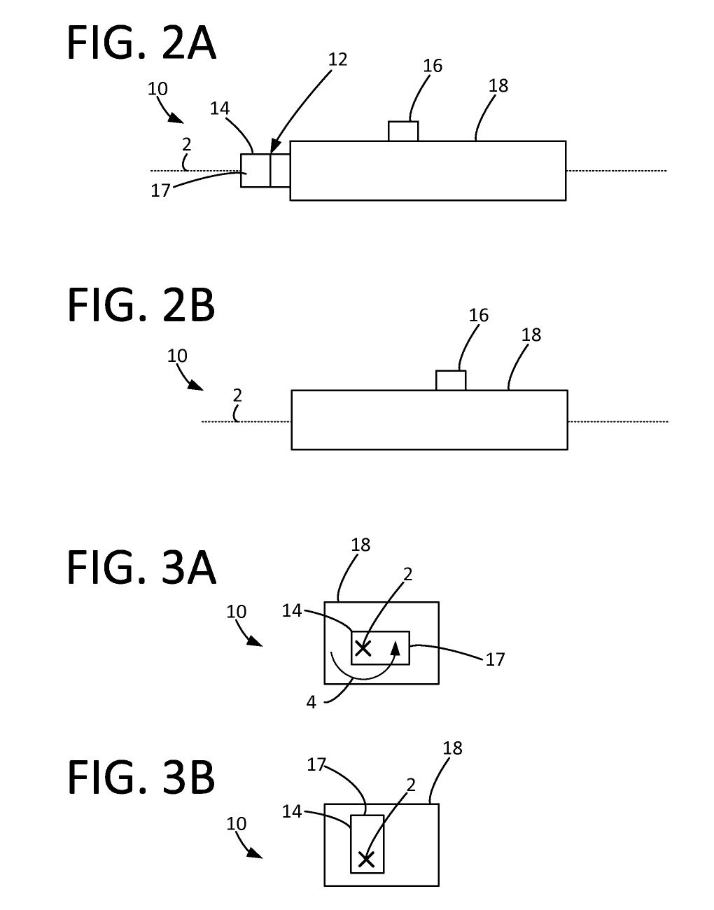

Generally, exemplary latch mechanisms 10 may include a latch bolt 12 that may extend into the latch channel 32 to keep, or maintain, the sash 22 from tilting. As shown in the side views of the latch mechanism in FIGS. 2A-2B, the latch bolt 12 may extend from a handle portion 16 to a foot portion 14 and may be configured to move between a refracted position (as shown in FIG. 2B) and an extended position (as shown in FIG. 2A) along a bolt axis 2. To move the latch bolt 12 between the retracted position and the extended position, a user may push or pull a handle portion 16 (as indicated in FIG. 1) coupled to the latch bolt 12 in directions substantially parallel to the bolt axis 2. In one or more embodiments, the latch bolt 12 may be biased in a particular, or selected, direction along the bolt axis 2. For example, the latch bolt 12 may be biased into the extended position using, e.g., a spring.

The latch bolt 12 may include a foot portion 14 that is configured to be located in the latch channel 32 when the latch bolt 12 is in the extended position to keep, or maintain, the sash 22 from tilting and may not be located in the latch channel 32 when the latch bolt is in the retracted position to allow, or permit, the sash to tilt. In other words, the foot portion 14 of the latch bolt 12 may be extended into the channel 32 to keep, or maintain, the sash 22 from tilting and may be retracted to allow, or permit the sash 22 to tilt.

The latch bolt 12 of the exemplary latch mechanism 10 may be additionally configured to rotate 4 about the bolt axis 2 from an insertion position to an engagement position as shown in the end views of the latch mechanism in FIGS. 3A-3B. The engagement position as shown in FIG. 3A may define a position in which a bearing surface 17 of the latch bolt 12 may engage at least one portion of the channel 32, such as a leg portion 36, (e.g., to provide more secure engagement between the latch mechanism 10 and channel 32) and the insertion position as shown in FIG. 3B may define a position in which the latch bolt 12 may be located, or moved, into the channel 32. The bearing surface 17 or end of the foot portion 14 of the latch bolt 12 may be defined by a variety of shapes to, e.g., assist or facilitate rotation within the channel. For example, the bearing surface 17 and/or the end of the foot portion 14 may be rounded (e.g., hemispherical, etc.). When in the engagement position, one or more portions of the foot portion 14 of the latch bolt 12 may be located closer to one or both leg portions 36 of the channel 32 than, or compared to, when in the insertion position.

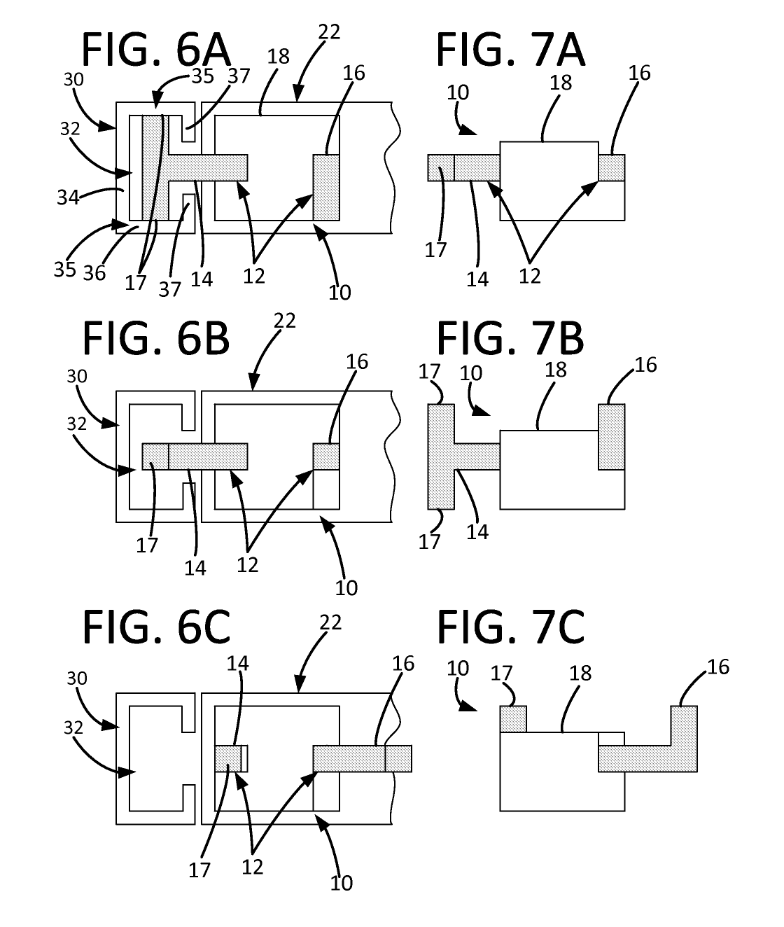

For example, a bearing surface, or end, 17 of the foot portion 14 may be located closer to the leg 36 of the L-shaped portion 35 of the latch channel 32 when the latch bolt 12 is in the engagement position than when the latch bolt 12 is in the insertion position as shown in the exemplary embodiment depict in FIG. 4A. Further, for example, a pair of bearing surfaces 17 of the foot 14 (e.g., a T-shaped foot portion) may be located closer to the leg of both L-shaped portions 35 of the latch channel 32 when the latch bolt is in the engagement position than when the latch bolt 12 is in the insertion position as shown in the exemplary embodiment depicted in FIG. 6A. Since the foot portion 14 is rotated, the foot portion 14 of the latch bolt 12 cannot be inserted into the latch channel 32 when the latch bolt 12 is in the engagement position. In other words, the foot portion 14 may be rotated such that is cannot slide into the channel 32 when in the engagement position. In one or more embodiments, the latch bolt 12 may be biased in a particular, or selected, direction about the bolt axis 2. For example, the latch bolt 12 may be biased into the engagement position using, e.g., a spring.

The latch bolt 12 may be configured to rotate about the bolt axis 2 at the same time or at a different time than when the latch bolt 12 is moved between the retracted and extended positions. For example, the latch bolt 12 may be configured to rotate from the insertion position to the engagement position as the latch bolt 12 is moved from the retracted position to the extended position (e.g., a camming action, spiraling action, spring-actuated camming action, spring-actuated spiraling action, etc.). Or, for example, the latch bolt 12 may be configured to be rotated from the insertion position to the engagement position after the latch bolt 12 has moved from the retracted position to the extended position.

It may be described that the flange 37 of the latch channel 32 is located between the bearing surface 17, or end, of the foot portion 14 of the latch bolt 12 and the sash 22 when that latch bolt 12 is in the engagement position and that the flange 37 of the latch channel 32 is not located between the bearing surface, or end, 17 of the foot portion 14 of the latch bolt 12 of the latch mechanism 10 and the sash 22 when that latch bolt 12 is in the insertion position (e.g., to allow insertion of the latch bolt 12 into the channel 32).

When the latch bolt 12 is in the extended position and the engagement position as depicted in FIG. 4A, the bearing surface 17 may engage (e.g., touch, be adjacent to, etc.) the leg 36 of the channel 32 to, for example, provide additional support and/or force dispersal (to, e.g. withstand winds and/or other forces such as from hurricanes). More specifically, if a force (e.g., a force at least partially perpendicular to the bolt axis 2) were applied to the sash 22, the force may be dispersed through the latch bolt 12 into the channel 32 (and, thus the jamb of the window). With the exemplary tilt latch mechanism 10, the force would be dispersed to the bearing surface 17 of the foot portion 14 into the leg 17 of channel 32, which, e.g., may provide a greater, or larger, surface area for the force to be dispersed into the channel 32.

In FIG. 4A, the jamb 30 depicted is located on the left side of the window assembly when facing the window assembly. As shown, the bearing surface, or end, 17 of the latch bolt 12 is configured to engage the leg 36 of the channel 32 that is located towards the inside (e.g., indoor side, interior, interior side, etc.), of the window assembly. In other embodiments, the bearing surface, or end, 17 of the latch bolt 12 may be configured to engage the leg 36 of the channel 32 that is located towards the outside (e.g., outside side, exterior, exterior side, etc.), of the window assembly. In other embodiment, such as the embodiment depicted in FIGS. 6-7, two bearing surfaces, or ends, 17 of the latch bolt 12 may be configured to engage the leg 36 of the channel 32 that is located towards the inside, or in-door side, of the window assembly and the leg 36 of the channel 32 that is located towards the outside, or outside side, of the window assembly.

The exemplary tilt latch mechanism 10 depicted in FIGS. 4-5 includes a latch bolt 12 including a handle portion 16 that is configured to rotate. As shown in FIGS. 4A and 5A, the latch bolt 12 is positioned, or moved into, the engagement position. When in the engagement position, the handle portion 16 of the latch bolt 12 may be folded down into a handle slot of a latch body 18 of the latch mechanism 10. To move the latch bolt 12 out of the engagement position, a user may grasp the handle portion 16 and rotate the handle portion 16, and thus, the latch bolt 12, away from the handle slot of the latch body 12. As the handle portion 16 is rotated away from the slot, a foot portion 14 of the latch bolt 12 may also rotate away from engagement with the channel 32 until the latch bolt 12 is in the insertion position as depicted in FIGS. 4B and 5B. The latch bolt 12 may then be moved out of the channel 32 by grasping the handle portion 16 and moving the handle portion 16 away from the channel 32 until the latch bolt 12 (e.g., the foot portion 14) has been removed from the channel 32 and is located in a foot slot of the latch body 18 (which, e.g., is the retracted position) as shown in FIGS. 4C and 5C.

Another exemplary latch mechanism 10 is depicted in FIGS. 6-7 that includes a latch bolt 12 having a “T”-shaped foot portion 14. The “T”-shaped foot portion 14 may define a pair of opposing bearing surfaces, or ends, 17 that each engage a portion of the channel 32 (e.g., the pair of opposing leg portions 36 of the channel 32) as shown in FIG. 6A as the latch bolt 12 is located in the engagement position. The positions of the exemplary latch mechanism 10 of FIGS. 6-7 may be substantially similar to the positions of the exemplary latch mechanism 10 of the FIGS. 4-5.

In one or more embodiments, the exemplary latch mechanisms may be built into, or integrated with, the sash itself. For example, an upper portion of the sash may contain, or house, the latch mechanism such that no portion except the handle portion of the latch mechanism may extend above the upper portion of the sash. In at least one embodiment, no portion of the exemplary latch mechanism may be visible or may extend above the upper portion of the sash. For example, the exemplary latch mechanisms may be integrated into the sash such that other functional elements of the sash such as, e.g., a sash lock, a lever, etc., may be used to operate the exemplary latch mechanism (e.g., any type of connection or linkage may be used to connect the functional elements of the sash to the exemplary latch mechanisms to operate the latch mechanisms). In at least one embodiment, one or more sash locks may be operably coupled (e.g., through one or more linkage elements such as adjustable or nonadjustable members, cords, etc.) to the exemplary latch mechanisms to provide movement of the latch bolt between the extended and retracted positions as well as the insertion and engagement positions.

The exemplary latch mechanisms described herein may include one or more materials such as, e.g., polymers such as nylon, polymer composites, engineered polymers (e.g., fiberglass-reinforced nylon), etc. and/or metals such as steel, aluminum, tin, zinc, metal alloys (e.g., Zamak 3, Zamak 5, etc.), etc.

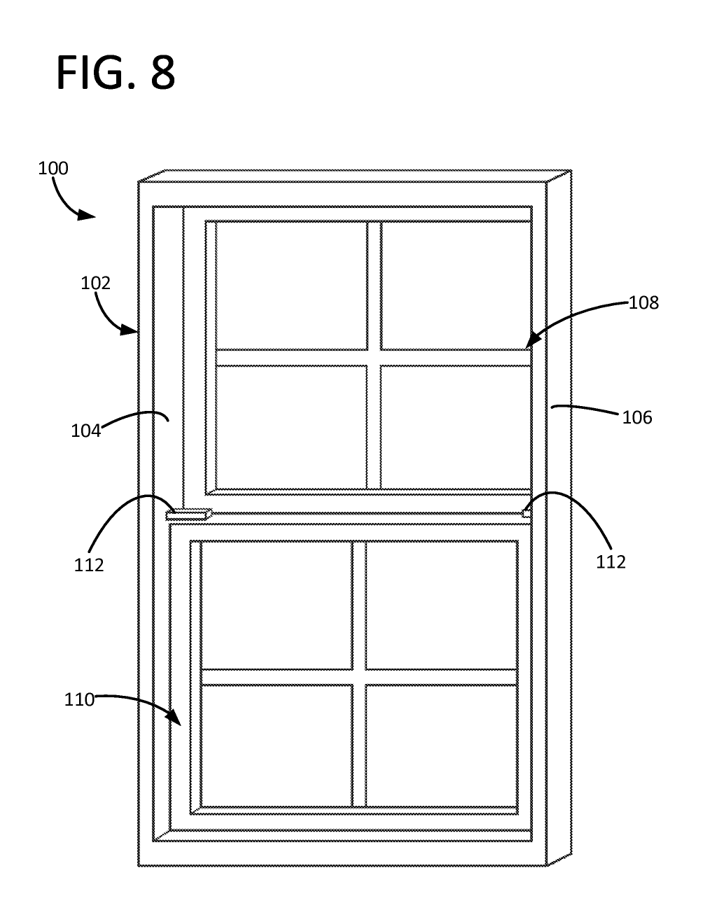

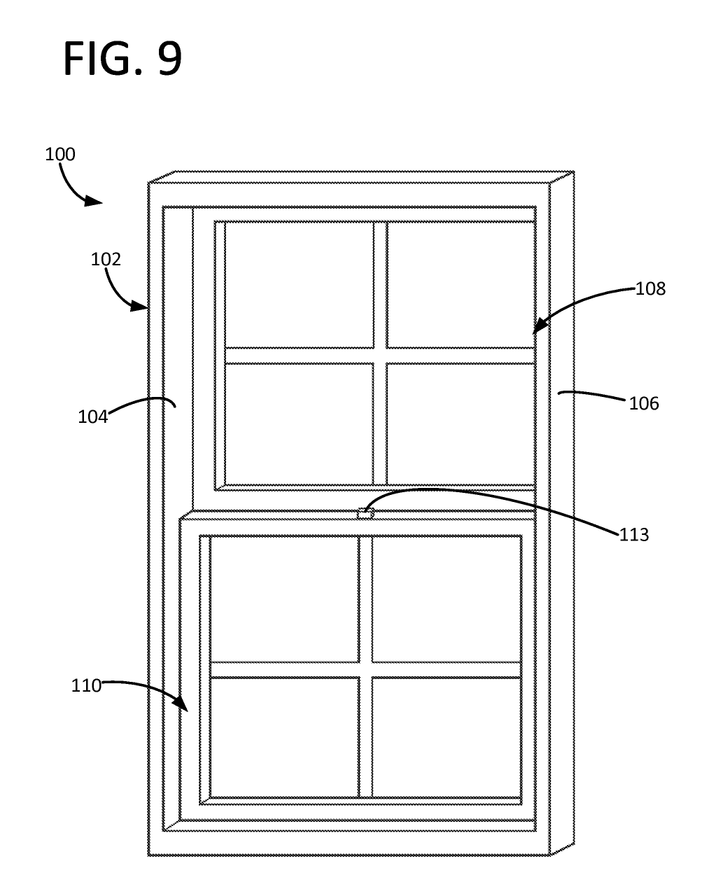

Exemplary tilt window assemblies 100 are depicted in FIGS. 8-9. The window frame 102 of the tilt window assemblies 100 includes a first jamb 104 on a left side of the assembly 100 and a second jamb 106 on the right side of the assembly 100 and defines a frame opening within which a first sash 108 and a second sash 110 are mounted. One or both of the first sash 108 and the second sash 110 may be moved upwardly and downwardly within the window frame 102 to open and close the window assembly 100.

For example, the second sash 110 (or the first sash 108) may be described as being located between the first and second jambs 104, 106 and configured to move along a length of the first and second jambs 104, 106 between an open position and a closed position. When the second sash 110 is in the open position, the window assembly 100 may be described as being open, and when the second sash 110 is in the closed position, the window assembly 100 may be described as being closed.

A pair of latch mechanisms 112 may be attached to a top, or upper, portion of the second sash 110 (e.g., lower sash) to keep, or maintain, the second sash 110 from tilting as shown in FIG. 8. The latch mechanisms 112 may be used to mate with, or be coupled to, latch channels located in the first jamb 104 and second jamb 106, respectively.

The exemplary tilt window 100 assembly of FIG. 9 includes a sash lock mechanism 113 that is at least partially built into, or integrated with, the second sash 110. The sash lock mechanism 113 may be configured to be a window lock to e.g., restrict movement of the first sash with respect to the second sash (e.g., to lock the window). The sash lock mechanism 113 may also be operatively coupled to at least one of the exemplary latch mechanisms described herein. As such, the sash lock mechanism 113 may be configured to move the latch bolts between the retracted, insertion, extended, and engagement positions as described herein. In other words, exemplary latch mechanisms described herein may be integrated into sash lock mechanisms 113. Additionally, one or more portions of the exemplary latch mechanisms may be integrated within the second sash 110 (e.g., within the frame of the second sash) so as to, e.g., hide one or more portions of the exemplary latch mechanisms from plain view.

In at least one embodiment, each of the jambs 104, 106 may define one or more engageable features within the respective latch, or jamb, channels that may be configured to be engaged by the latch bolt, or other part, of the exemplary latch mechanisms or apparatus described herein. The engageable features may allow the exemplary latch mechanisms or apparatus to further operate, or function, as a sash locking device. In other words, not only would the exemplary latch mechanisms or apparatus operate as a tilt latch but also as a sash locking device.

Further, the exemplary latch mechanisms described herein may be used with other products such as, e.g., doors, horizontal sliding windows, etc. In at least one embodiment, the exemplary latch mechanisms, or parts thereof, may be integrated with a “shoot bolt.”

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the exemplary apparatus described herein. Various modifications of the illustrative embodiments, as well as additional embodiments of the disclosure, will be apparent upon reference to this description.

What is claimed is:

1. A tilt window assembly comprising:
a window frame including a first jamb and a second jamb, wherein the window frame defines a frame opening;
a first sash mounted in the frame opening between the first and second jambs;
a second sash mounted in the frame opening between the first and second jambs, wherein the second sash is configured to move along a length of the first and second jambs between an open position and a closed position;
a first latch channel in the first jamb, wherein the first latch channel extends along a first longitudinal axis, wherein the first latch channel comprises, in a cross-sectional view taken transverse to the first longitudinal axis, a base located distal from the first and second sashes and an L-shaped portion extending away from the base towards the first and second sashes, the L-shaped portion comprising a leg and a flange extending from the leg, wherein the flange is aligned with the base and the leg connects the flange to the base;
a first latch mechanism attached to the second sash, wherein the first latch mechanism comprises a latch bolt configured to move between a retracted position and an extended position along a bolt axis, wherein the latch bolt comprises a foot portion located in the first latch channel when the latch bolt is in the extended position, and wherein latch bolt is configured to rotate about the bolt axis from an insertion position to an engagement position, wherein a bearing end of the foot portion is located closer to the leg of the L-shaped portion of the first latch channel when the latch bolt is in the engagement position than when the latch bolt is in the insertion position;
a second latch channel in the second jamb, wherein the second latch channel extends along a second longitudinal axis, wherein the second latch channel comprises, in a cross-sectional view taken transverse to the second longitudinal axis, a base located distal from the first and second sashes and an L-shaped portion extending away from the base towards the first and second sashes, the L-shaped portion comprising a leg and a flange extending from the leg, wherein the flange is aligned with the base and the leg connects the flange to the base; and
a second latch mechanism attached to the second sash, wherein the second latch mechanism comprises a latch bolt configured to move between a retracted position and an extended position along a bolt axis, wherein the latch bolt of the second latch mechanism comprises a foot portion located in the second latch channel when the latch bolt is in the extended position, and wherein latch bolt of the second latch mechanism is configured to rotate about the bolt axis from an insertion position to an engagement position, wherein a bearing end of the foot portion is located closer to the leg of the L-shaped portion of the second latch channel when the latch bolt is in the engagement position than when the latch bolt is in the insertion position.

2. A tilt window assembly of claim 1, wherein the foot portion of the latch bolt of the first latch mechanism cannot be inserted into the first latch channel when the latch bolt of the first latch mechanism is in the engagement position.

3. A tilt window assembly of claim 1, wherein the foot portion of the latch bolt of the second latch mechanism cannot be inserted into the second latch channel when the latch bolt of the second latch mechanism is in the engagement position.

4. A tilt window assembly of claim 1, wherein the flange of the first latch channel is located between the bearing end of the foot portion of the latch bolt of the first latch mechanism and the second sash when that latch bolt is in the engagement position, and wherein the flange of the first latch channel is not located between the bearing end of the foot portion of the latch bolt of the first latch mechanism and the second sash when that latch bolt is in the insertion position.

5. A tilt window assembly of claim 1, wherein the flange of the second latch channel is located between the bearing end of the foot portion of the latch bolt of the second latch mechanism and the second sash when that latch bolt is in the engagement position, and wherein the flange of the second latch channel is not located between the bearing end of the foot portion of the latch bolt of the second latch mechanism and the second sash when that latch bolt is in the insertion position.

6. The tilt window assembly of claim 1, wherein the tilt window assembly further comprises a sash lock mechanism configured to restrict movement between the first sash and the second sash when engaged, wherein at least one of the first latch mechanism and the second latch mechanism are operatively coupled to the sash lock mechanism to move the latch bolt into the retracted position, the extended position, the insertion position, and the engagement position.

7. The tilt window assembly of claim 1, wherein at least one of the first latch mechanism and the second latch mechanism are integral into the second sash.

8. Latch apparatus for use in a tilt window assembly including a first sash and a second sash and defining a latch channel in a jamb, wherein the latch channel extends along a longitudinal axis and comprises, in a cross-sectional view taken transverse to the longitudinal axis, a base located distal from the first and second sashes and an L-shaped portion extending away from the base towards the first and second sashes, the L-shaped portion comprising a leg and a flange extending from the leg, wherein the flange is aligned with the base and the leg connects the flange to the base, wherein the latch apparatus comprises:
a latch bolt configured to move between a retracted position and an extended position along a bolt axis, wherein the latch bolt comprises a foot portion located in the latch channel when the latch bolt is in the extended position, and wherein latch bolt is configured to rotate about the bolt axis from an insertion position to an engagement position, wherein a bearing end of the foot portion is located closer to the leg of the L-shaped portion of the first latch channel when the latch bolt is in the engagement position than when the latch bolt is in the insertion position.

9. The latch apparatus of claim 8, wherein the foot portion of the latch bolt cannot be inserted into the latch channel when the latch bolt of the latch mechanism is in the engagement position.

10. The latch apparatus of claim 8, wherein the flange of the latch channel is located between the bearing end of the foot portion of the latch bolt of the latch mechanism and the second sash when that latch bolt is in the engagement position, and wherein the flange of the latch channel is not located between the bearing end of the foot portion of the latch bolt of the latch mechanism and the second sash when that latch bolt is in the insertion position.

11. The latch apparatus of claim 8 further comprising a sash lock mechanism configured to restrict movement between the first sash and the second sash when engaged and operatively coupled to the latch bolt to move the latch bolt into the retracted position, the extended position, the insertion position, and the engagement position.

12. The latch apparatus of claim 8 further comprising a latch body coupled the second sash, wherein the latch body is movably coupled to the latch body.

13. The latch apparatus of claim 12, wherein the latch body is integral with the second sash.

14. The latch apparatus of claim 8, wherein the bearing end of the foot portion is rounded.

15. The latch apparatus of claim 8, wherein the foot portion is T-shaped.

16. Latch apparatus for use in a tilt window assembly including a window sash, wherein the latch apparatus comprises:
a latch body couplable to a window sash; and
a latch bolt movably coupled to the latch body and configured selectively allow the window sash to tilt, wherein the latch bolt is configurable in a retracted position and an extended position, wherein the latch bolt restricts the sash from tilting when in the extended position and allows the sash to tilt when in the retracted position, wherein the latch bolt is configured to move between a retracted position and an extended position along a bolt axis,
wherein the latch bolt is further configured to selectively provide additional support to the tilt window assembly when in the extended position, wherein the latch bolt is configured to rotate about the bolt axis from an insertion position to an engagement position, wherein the latch bolt provides additional support to the tilt window assembly when in an engagement position.

17. The latch apparatus of claim 14, wherein the latch bolt comprises a foot portion locatable in a latch channel when the latch bolt is in the extended position, and wherein a bearing end of the foot portion is located proximate a surface of the tilt window assembly parallel to the bolt axis when the latch bolt is in the engagement position.

18. The latch apparatus of claim 14, wherein the latch bolt comprises a foot portion locatable in a latch channel when the latch bolt is in the extended position, wherein the foot portion of the latch bolt cannot be inserted into the latch channel when the latch bolt of the latch mechanism is in the engagement position.

19. The latch apparatus of claim 14 further comprising a sash lock mechanism configured to restrict movement between the window sash and another window sash when engaged and operatively coupled to the latch bolt to move the latch bolt into the retracted position, the extended position, the insertion position, and the engagement position.

20. The latch apparatus of claim 14, wherein the latch body is integral with the window sash.
